(19) United States
(12) Patent Application Publication
(10) Pub. No.: US 2024/0173835 A1
(43) Pub. Date: May 30, 2024

(54) ELECTRIC STAPLER

(71) Applicant: KIHIN DO, Nagoya (JP)

(72) Inventor: KIHIN DO, Nagoya (JP)

(21) Appl. No.: 18/094,348

(22) Filed: Jan. 7, 2023

(30) Foreign Application Priority Data
Nov. 24, 2022 (CN) 202223150442.3
Nov. 24, 2022 (CN) 202223177921.4

(51) Int. Cl. B25C 5/02; B25C 5/15

(52) U.S. Cl. CPC B25C 5/0228; B25C 5/15

(57) ABSTRACT

An electric stapler, comprising a base on which a staple frame and a nail pressing mechanism are arranged. The nail pressing mechanism comprises a nail pressing gear pressing the staple frame and a motor driving the nail-pressing gear to rotate. A first and second auxiliary nail pressing component are arranged on both sides of the base, and are connected to the nail pressing gear through the connecting shaft, and the first and second auxiliary nail pressing component respectively push against the two ends of the connecting shaft, so that the connecting shaft drives the nail pressing gear to press the staple frame, both the first and second auxiliary nail pressing component comprises a pressure spring for making the connecting shaft always have a tendency to move downward. The upper end of the pressure spring abuts against the machine base, the lower end abuts against the connecting shaft.

### CROSS-REFERENCE TO RELATED APPLICATIONS

This is a U.S. patent application which claims the priority and benefit of Chinese Patent Application Number 202223177921.4, filed on Nov. 24, 2022 and Chinese Patent Application Number 202223150442.3, filed on Nov. 24, 2022, the disclosure of which is incorporated herein by reference in its entirety.

### TECHNICAL FIELD

The present application relates to the technical field of staplers, in particular to an electric stapler.

### BACKGROUND

The common office stationery staplers on the market are generally manually typed, which requires manual operation and is inconvenient to use. Therefore, in order to overcome the inconvenient defect of the manual stapler, an electric stapler has appeared on the market, which mainly comprises a base, a staple frame and a nail pressing mechanism. The nail pressing mechanism comprises a nail pressing gear and a motor, and the motor controls the nail pressing gear rotates, and the eccentric wheel on the nail pressing gear presses the staple frame, so that the staples in the staple frame are pressed into the paper.

However, the existing electric staplers are generally suitable for binding thinner paper, and can only bind 20 sheets of paper under the condition of extreme force, which is difficult to bind more than 20 sheets of thicker paper.

### SUMMARY

The present application aims at the deficiencies in the prior art, and provides an electric stapler, which uses the combination of the nail pressing mechanism and the auxiliary nail pressing component to increase the pressing force of the nail pressing gear, and the binding ability is stronger, which can satisfy the binding of more than 20 sheet of thicker paper.

In order to achieve the above object, the present application adopts the following technical solutions:

An electric stapler, comprising a base, the base is provided with a staple frame and a nail pressing mechanism, the nail pressing mechanism comprises a nail pressing gear and a motor driving the nail pressing gear to rotate, and the nail pressing gear presses against the staple frame, so that the staples in the staple frame are pressed into papers, wherein auxiliary nail pressing components are also provided on the base, and the auxiliary nail pressing components are connected to the nail pressing gear through a connecting shaft, and the auxiliary nail pressing components push against the connecting shaft, so that the connecting shaft drives the nail pressing gear to abut against the staple frame. By adding the auxiliary nail pressing component, the auxiliary nail pressing component is connected with the nail pressing gear through the connecting shaft, and the auxiliary nail pressing component is used to push the connecting shaft, so that the connecting shaft drives the nail pressing gear to press the staple frame. The combination of the nail pressing mechanism and the auxiliary nail pressing component makes the nail pressing gear get extra thrust and increases the pressure of the nail pressing gear on the staple frame, making the binding ability stronger and able to meet the requirements for bonding 20 sheets of thicker paper, maximal bonding 45 sheets of thicker paper.

As a preferred solution, waist-shaped holes are respectively provided on both sides of the lateral direction of the base, and the extension direction of the waist-shaped holes is the same as the radial direction of the connecting shaft, and the both ends of the connecting shaft are radially movable arranged in the corresponding waist-shaped holes.

As a preferred solution, the auxiliary nail pressing component comprises a first auxiliary nail pressing component and a second auxiliary nail pressing component, and the first auxiliary nail pressing component and the second auxiliary nail pressing component abut against both ends of the connecting shaft respectively.

As a preferred solution, the auxiliary nail pressing component comprises a pressure spring for making the connecting shaft always have a tendency to move downward, the upper end of the pressure spring abuts against the base, and the lower end of the pressure spring abuts against the connecting shaft.

As a preferred solution, the elastic force of the pressure spring is greater than the resistance of the staple frame to press the staple into the paper.

As a preferred solution, the auxiliary nail pressing component comprises a lever and a pressure spring, the lower end of the pressure spring is in contact with the base, and the upper end of the pressure spring is in contact with one end of the lever abut against, so that the end of the lever away from the compression spring always has a tendency to push the connecting shaft to move downward.

As a preferred solution, the lever comprises a main body, and one end of the main body close to the pressure spring is bent upwards to form a first connecting part, and the first connecting part comprises a blocking sheet extending laterally outwards, and the upper end of the pressure spring abuts against the blocking sheet.

As a preferred solution, the end of the main body away from the pressure spring is bent upwards to form a second connecting part, and the second connecting part is provided with a pushing groove matched with the connecting shaft, the inner side wall of the pushing groove abuts against the circumferential outer surface of the connecting shaft.

As a preferred solution, one end of the second connecting part close to the corresponding main body is rotatably connected to the base through a rotating shaft.

As a preferred solution, the elastic force of the pressure spring is greater than the resistance of the staple frame to press the staple into the paper.

Compared with the prior art, the present application has obvious advantages and beneficial effects, specifically, by adding the auxiliary nail pressing component, the auxiliary nail pressing component is connected with the nail pressing gear through the connecting shaft, and the auxiliary nail pressing component is used to push the connecting shaft, so that the connecting shaft drives the nail pressing gear to press the staple frame. The combination of the nail pressing mechanism and the auxiliary nail pressing component makes the nail pressing gear get extra thrust and increases the pressure of the nail pressing gear on the staple frame, making the binding ability stronger and able to meet the requirements for bonding 20 sheets of thicker paper, maximal bonding 45 sheets of thicker paper.

In order to more clearly illustrate the structural features, technical means and the specific purpose and functions achieved by the application, the application will be further described in detail in conjunction with the accompanying drawings and specific embodiments below:

### BRIEF DESCRIPTION OF DRAWINGS

FIG. 1 is a schematic structural diagram of the embodiment of the present application in the assembled state;

FIG. 2 is a first exploded schematic diagram of the embodiment of the present application;

FIG. 3 is a second exploded schematic diagram of the embodiment of the present application;

FIG. 4 is a reference diagram of the embodiment of the present application in a first use state;

FIG. 5 is a reference diagram of the embodiment of the present application in a second use state;

FIG. 6 is a schematic structural diagram of another embodiment of the present application in the assembled state;

FIG. 7 is a schematic diagram of the internal structure of another embodiment of the present application;

FIG. 8 is an exploded schematic diagram of another embodiment of the present application;

FIG. 9 is a reference diagram of another embodiment of the present application in a first use state;

FIG. 10 is a reference diagram of another embodiment of the present application in a second use state.

### REFERENCE SIGNS

10—Base 11—Paper inlet 12—Waist hole
13—Blocking plate 131—Relief opening 14—Guiding pin
20—Staple frame 21—Upper knife rest 211—Pressing knife
22—Lower bracket 23—Movement 30—Nail pressing mechanism
31—Nail pressing gear 311—First pressing nail gear 312—Second pressing nail gear
313—Eccentric wheel 314—Shaft sleeve 32—Motor
33—Transmission gear 40—Auxiliary nail component 41—First auxiliary nail component
42—Second auxiliary nail component 43—Pressure spring 44—Connecting block
441—Connecting hole 45—limiting guide rod 50—Lever
51—Main body 52—First connecting part 521—Blocking sheet
522—Relief through hole 523—Curved guiding hole 53—Second connecting part
531—Pushing groove 532—Connecting plate 54—Rotating shaft
55—Limiting sleeve 56—Connecting rod 561—Limiting protrusion
60—Connecting shaft 70—Paper X—Lateral direction
Z—Up and down direction

### DETAILED DESCRIPTION

In the description of the present application, it should be noted that the orientation or positional relationship indicated by terms “center”, “upper”, “lower”, “left”, “right”, “vertical”, “horizontal”, “inner” and the like is based on the orientation or positional relationship shown in the accompanying drawings, only for the convenience of describing the application, rather than indicating or implying that the device or element referred to must have a specific orientation, be constructed in a specific orientation, and operate, and thus should not be construed as limiting the application. In addition, the terms “first”, “second”, and “third” are used for descriptive purposes only, and should not be construed as indicating or implying relative importance.

In the description of the present application, it should be noted that, unless otherwise specified and limited, the terms “installation”, “connection” and “connected” should be understood in a broad sense. For example, it can be a fixed connection, a detachable connection, or an integral connection; it can be a mechanical connection or an electrical connection, it may be directly connected, or indirectly connected through an intermediary, and may be internally connected between two elements. A person skilled in the art can understand the specific meanings of the above terms in this application in specific situations.

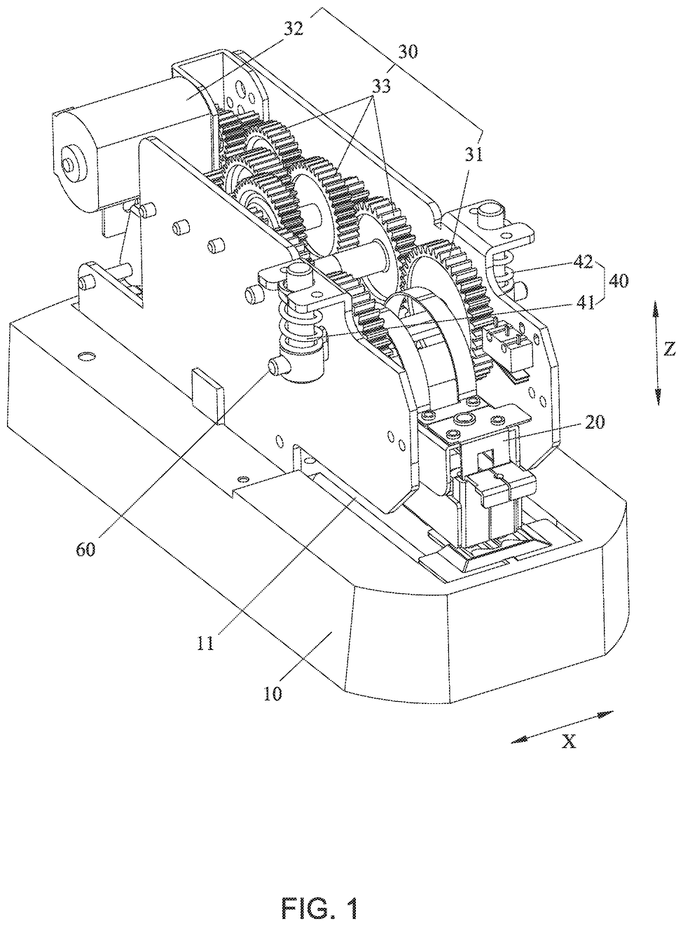

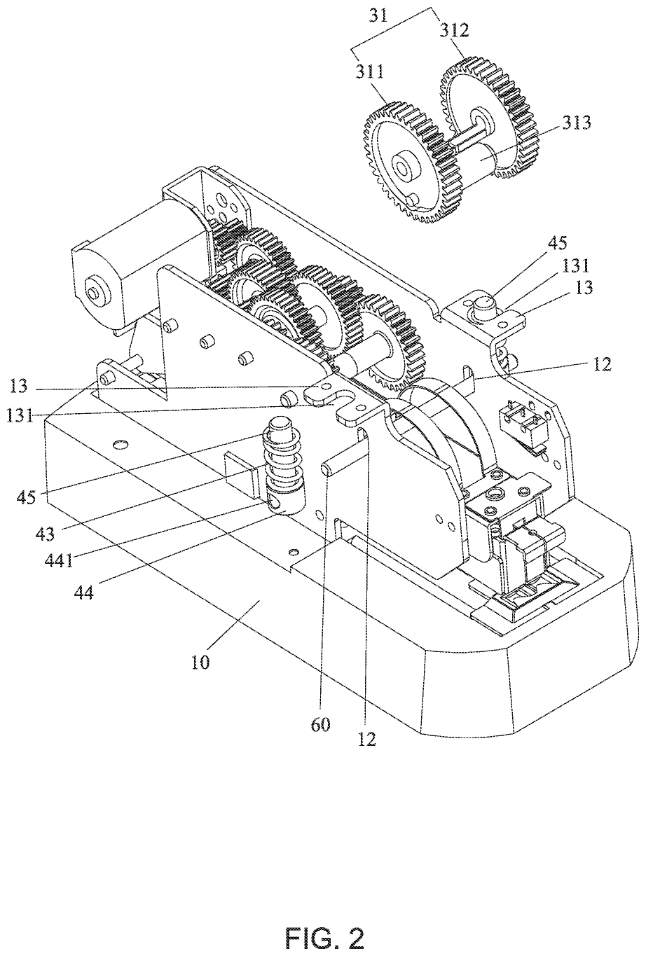

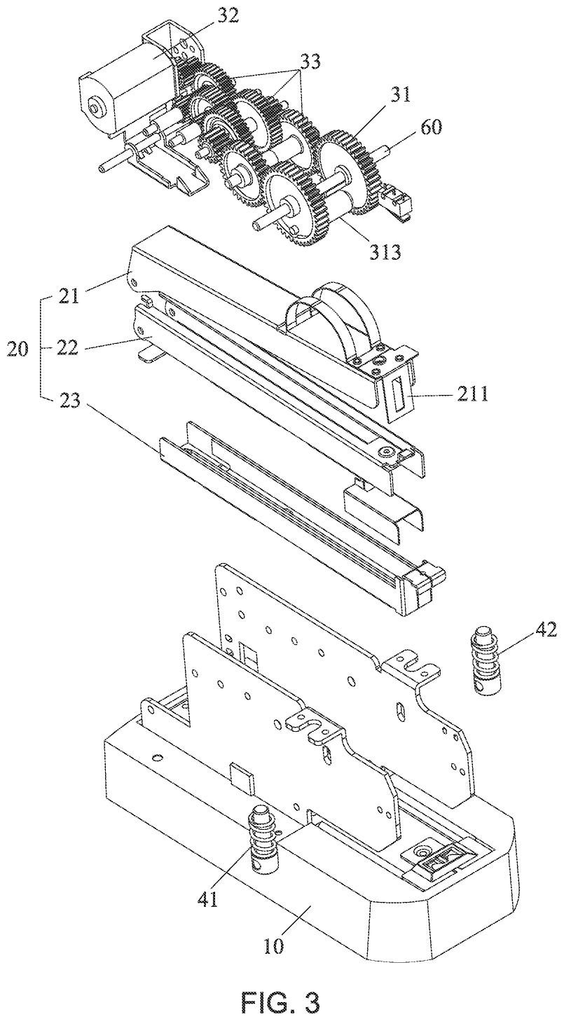

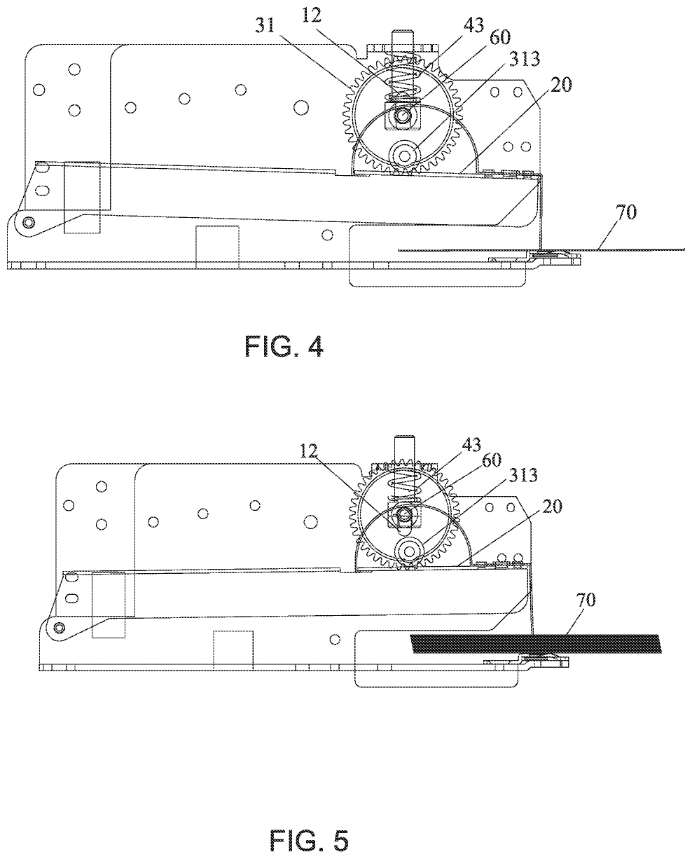

As shown in FIGS. 1-5, the present application discloses an electric stapler, comprising a base 10, on which a staple frame 20 and a nail pressing mechanism 30 are arranged. A paper inlet 11 is formed between the staple frame 20 and the base 10. The nail pressing mechanism 30 comprises a nail pressing gear 31 and a motor 32 that drives the nail pressing gear 31 to rotate. A plurality of transmission gears 33 are arranged between the nail pressing gear 31 and the motor 32. The plurality of transmission gears 33 can realize the function of deceleration and torque increase, and the nail pressing gear 31 presses against the staple frame 20, so that the staples in the staple frame 20 are pressed into the paper 70. The base 10 is also provided with auxiliary nail pressing component 40, and the auxiliary nail pressing component 40 is connected with the nail pressing gear 31 through the connecting shaft 60, and the auxiliary nail pressing component 40 pushes against the connecting shaft 60, so that the connecting shaft 60 drives the nail pressing gear 31 to abut against the staple frame 20.

In this embodiment, the staple frame 20 comprises an upper knife rest 21 and a lower bracket 22 arranged up and down, one end of the upper knife rest 21 and the lower bracket 22 is rotatably mounted on the base 10, and the lower bracket 22 is provided with a movement 23 capable of accommodating staples, the other end of the upper knife rest 21 is provided with a pressing knife 211. The nail pressing gear 31 comprises a first nail pressing gear 311 and a second nail pressing gear 312. The first nail pressing gear 311 and the second nail pressing gear 312 are connected through the connecting shaft 60, and an eccentric wheel 313 that presses against the staple frame 20 is arranged between the first nail pressing gear 311 and the second nail pressing gear 312. The two axial ends of the eccentric wheel 313 are respectively rotatably connected with the first nail pressing gear 311 and the second nail pressing gear 312. When the nail pressing gear 31 rotates, the nail pressing gear 31 drives the eccentric wheel 313 to rotate around the connecting shaft 60, so that the eccentric wheel 313 presses the upper knife rest 21 downwards, and then the pressing knife 211 presses the staples in the movement 23 into the paper 70.

Waist-shaped holes 12 are arranged on both sides of the base 10 in the lateral direction X, and the extension direction of the waist-shaped holes 12 is the same as the radial direction of the connecting shaft 60, and the both ends of the connecting shaft 60 are radially movable arranged in the corresponding waist-shaped holes 12; by setting the waist-shaped hole 12 on both sides of the base 10, the both ends of the connecting shaft 60 are penetrated in the waist-shaped hole 12. When the nail pressing gear 31 presses against the staple frame 20, the waist-shaped hole 12 can be used by the connecting shaft 60 to drive the nail pressing gear 31 to float radially upward for a short distance, thus avoiding the clamping of the nail pressing gear 31 and the staple frame 20, so that the nail pressing gear 31 can rotate in the circumferential direction more smoothly, which makes the binding effect better.

The auxiliary nail pressing component 40 comprises a first auxiliary nail pressing component 41 and a second auxiliary nail pressing component 42 arranged on both sides of the base 10 in the lateral direction X, and the first auxiliary nail pressing component 41 and the second auxiliary nail pressing component 41 abut against both ends of the connecting shaft 60 respectively, and the first auxiliary nail pressing component 41 and the second auxiliary nail pressing component 42 both comprise a pressure spring 43 for making the connecting shaft 60 always have a tendency to move downward. The upper end of the pressure spring 43 abuts against the base 10, the lower end of the pressure spring 43 abuts against the connecting shaft 60, and the elastic force of the pressure spring 43 is greater than the resistance of the staple frame 20 to press the staples into the paper 70.

Both the first auxiliary nail pressing component 41 and the second auxiliary nail pressing component 42 also comprise a connecting block 44, the base 10 is provided with a blocking plate 13 corresponding to the connecting block 44, and the blocking plate 13 is integrally connected to the base 10, the connecting block 44 is connected with the connecting shaft 60, the upper and lower ends of the pressure spring 43 respectively abut against the blocking plate 13 and the connecting block 44, and the connecting block 44 is provided with a limiting guide rod 45 extending upward, the pressure spring 43 is sleeved on the outside of the limiting guide rod 45, the blocking plate 13 has a relief opening 131 through which the limiting guide rod 45 passes upward, and the relief opening 131 runs through the side surface of the blocking plate 13, and the connecting block 44 is provided with a connecting hole 441 matched with the connecting shaft 60, and the connecting block 44 is sleeved on the connecting shaft 60 through the connecting hole 441.

### Working Principle of the Present Application:

Insert the paper 70 into the paper inlet 11, the motor 32 drives the transmission gear 33 and drives the nail pressing gear 31 to rotate, the nail pressing gear 31 drives the eccentric wheel 313 to rotate, the eccentric wheel 313 presses the upper knife rest 21 downward, and the upper knife rest 21 will generate a reaction force to the eccentric wheel 313, so that the connecting shaft 60 moves up in a short distance. At the same time, the pressure spring 43 pushes the connecting shaft 60 to move downward. When the eccentric wheel 313 turns to the lowermost end of the nail pressing gear 31, the eccentric wheel 313 is pressed against the upper knife rest 21 with the maximum pressing effect, thereby pressing the staples in the movement 23 into the paper 70.

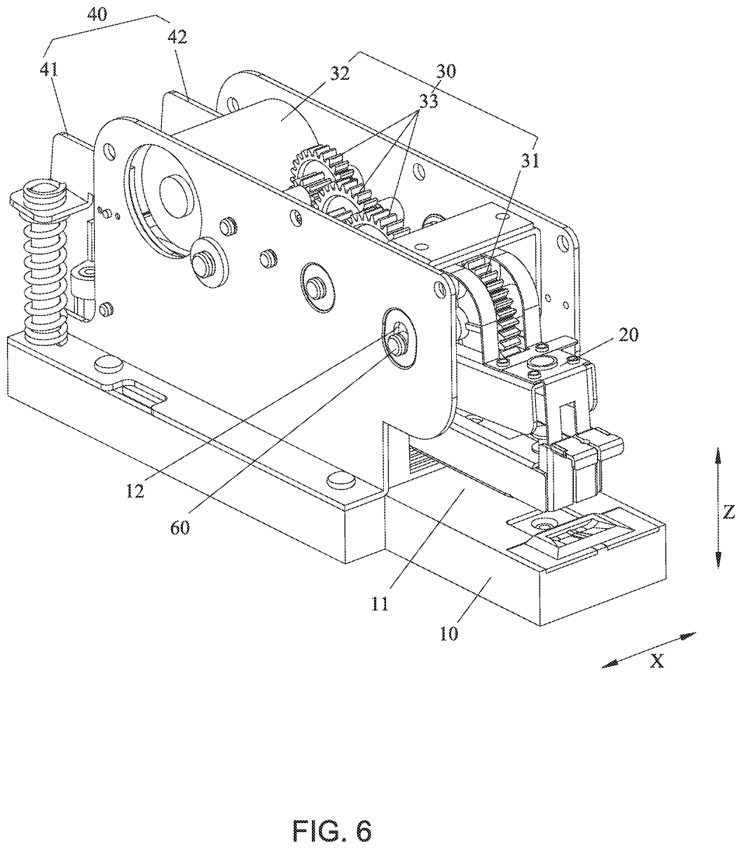

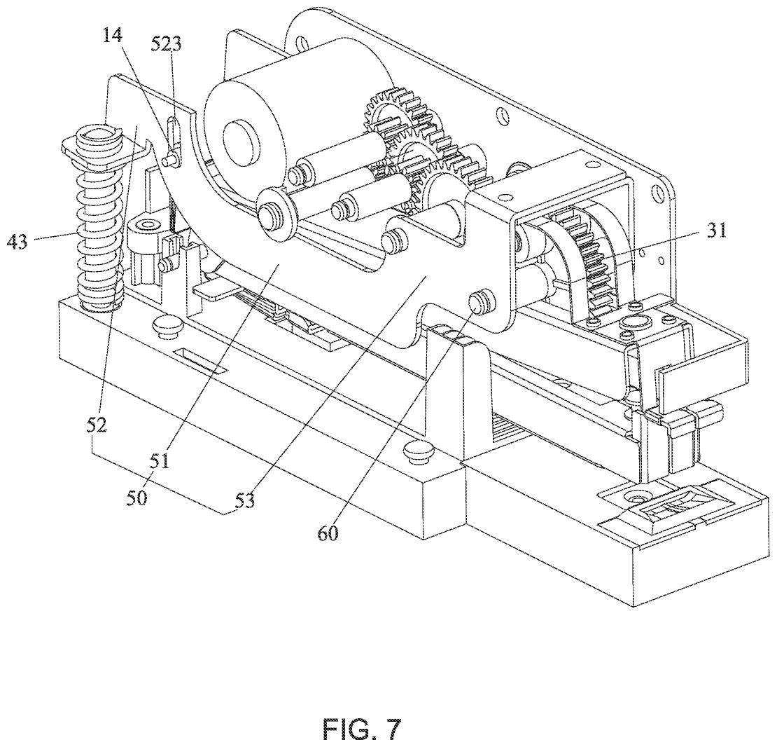

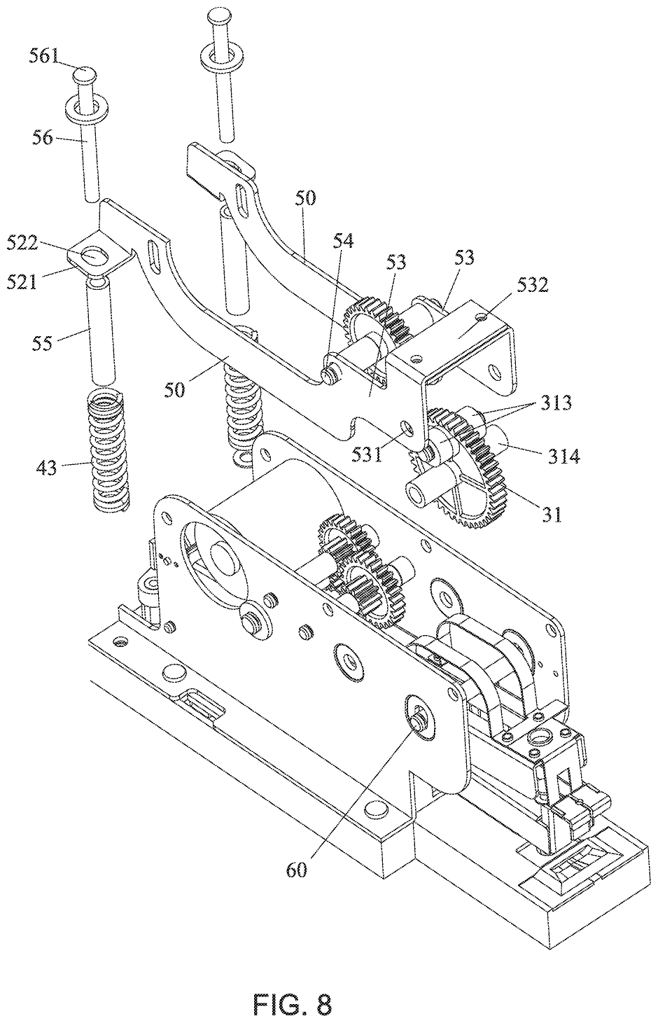

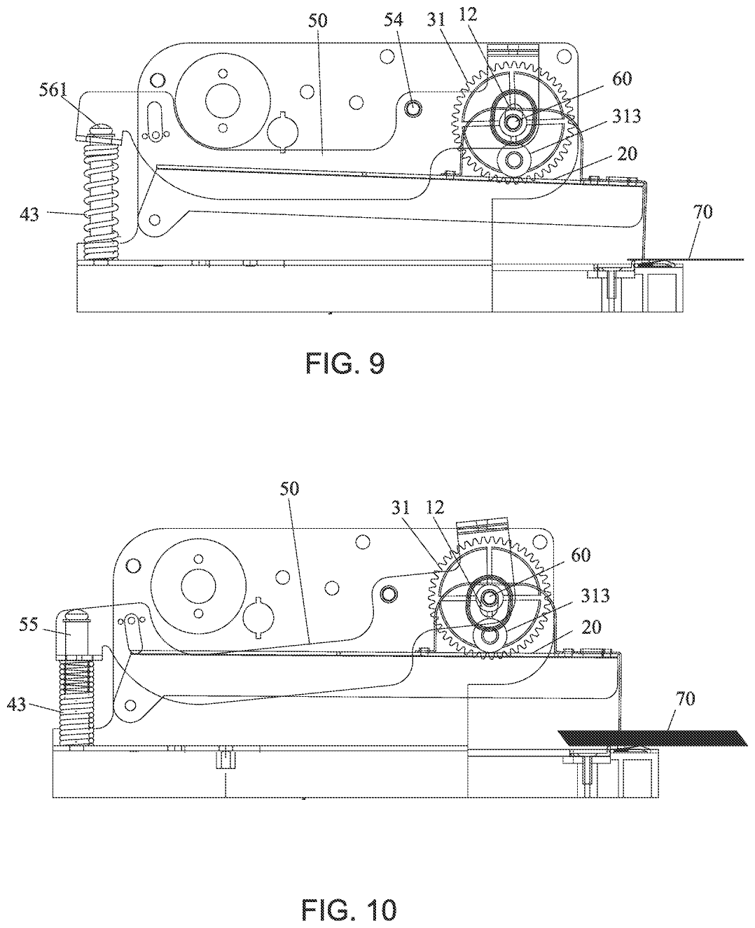

As shown in FIGS. 6-10, another embodiment of the present application differs from the above-mentioned embodiments in that the first auxiliary nail pressing component 41 and the second auxiliary nail pressing component 42 both comprise a lever 50 and a pressure spring 43, the lower end of the pressure spring 43 abuts against the base 10, and the upper end of the pressure spring 43 abuts against one end of the lever 50, so that the end of the lever 50 away from the pressure spring 43 always has a tendency to push the connecting shaft 60 to move downward.

The lever 50 comprises a main body 51, one end of the main body 51 close to the pressure spring 43 is bent upwards to form a first connecting part 52, and the first connecting part 52 comprises a blocking sheet 521 extending laterally outwards, so that the upper end of the pressure spring 43 abuts against the blocking piece 521, the end of the first connecting part 52 close to the main body 51 has a curved guiding hole 523, the base 10 is provided with a guiding pin 14. During assembly, the guiding pin 14 stretches into the curved guiding hole 523, and when the lever 50 swings, the guiding pin 14 moves along the curved guiding hole 523; by setting the curved guiding hole 523 and the guiding pin 14, the lever 50 is more stable when swinging by using the guiding function.

A limiting sleeve 55 is provided between the base 10 and the blocking sheet 521, and the pressure spring 43 is sleeved on the outside of the limiting sleeve 55. The blocking sheet 521 comprises a relief through hole 522 through which the limiting sleeve 55 passes upward, and the connecting rod 56 is sleeved inside the limiting sleeve 55, and the lower end of the connecting rod 56 is connected with the base 10. The upper end of the connecting rod 56 protrudes upwards outside the limiting sleeve 55, and the upper end of the connecting rod 56 forms a limiting protrusion 561, and the limiting protrusion 561 is located above the blocking sheet 521. By setting the limiting protrusion 561, when the lever 50 is swinging, the limiting protrusion 561 limits the upward movement of the blocking sheet 521, which can prevent the limiting sleeve 55 from being separated from the relief through hole 522, and has good reliability.

An end of the main body 51 away from the pressure spring 43 is bent upwards to form a second connecting part 53. The second connecting part 53 is provided with a pushing groove 531 matched with the connecting shaft 60, and the connecting shaft 60 extends into the pushing groove 531. The inner wall of the pushing groove 531 abuts against the peripheral outer surface of the connecting shaft 60. One end of the two second connecting parts 53 close to the corresponding main body 51 is rotatably connected to the base 10 through a rotating shaft 54. One end of the two second connecting parts 53 away from the corresponding main body 51 is rotatably connected to the base 10 through a rotating shaft 54. One end of the two second connecting parts 53 away from the corresponding main body 51 is connected by a connecting plate 532. The connecting plate 532 is provided to connect the two second connecting parts 53, so that the two levers 50 can synchronously push the connecting shaft 60 when rotating, and the stability is better. A shaft sleeve 314 is disposed in the middle of the nail pressing gear 31. The connecting shaft 60 is rotatably disposed in the shaft sleeve 314. Both axial sides of the nail pressing gear 31 are provided with eccentric wheels 313 for pressing against the staple frame 20.

In summary, in the present application, by adding the auxiliary nail pressing component 40, the auxiliary nail pressing component 40 is connected with the nail pressing gear 31 through the connecting shaft 60, and the auxiliary nail pressing component 40 is used to push the connecting shaft 60, so that the connecting shaft 60 drives the nail pressing gear 31 to press the staple frame 20. The combination of the nail pressing mechanism 30 and the auxiliary nail pressing component 40 makes the nail pressing gear 31 get extra thrust and increases the pressure of the nail pressing gear 31 on the staple frame 20, making the binding ability stronger and able to meet the requirements for bonding 20 sheets of thicker paper, maximal bonding 45 sheets of thicker paper.

The above is only a preferred embodiment of the application, and is not intended to limit the application. Therefore, any modification, equivalent replacement, improvement, etc. made to the above embodiments based on the technical practice of the present application still fall within the scope of the technical solution of the present application.

1. An electric stapler, comprising a base, the base is provided with a staple frame and a nail pressing mechanism, the nail pressing mechanism comprises a nail pressing gear and a motor driving the nail pressing gear to rotate, and the nail pressing gear presses against the staple frame, so that staples in the staple frame are pressed into papers, wherein auxiliary nail pressing components are also provided on the base, and the auxiliary nail pressing components are connected to the nail pressing gear through a connecting shaft, and the auxiliary nail pressing components push against the connecting shaft, so that the connecting shaft drives the nail pressing gear to abut against the staple frame,
wherein elongated holes are respectively provided on both sides of a lateral direction of the base, and an extension direction of the elongated holes is the same as a radial direction of the connecting shaft, and both ends of the connecting shaft are radially movable arranged in the corresponding elongated holes and can move in the corresponding elongated holes in an extension direction of the elongated holes.

2. (canceled)

3. The electric stapler according to claim 1, wherein the auxiliary nail pressing component comprises a first auxiliary nail pressing component and a second auxiliary nail pressing component, and the first auxiliary nail pressing component and the second auxiliary nail pressing component abut against both ends of the connecting shaft respectively.

4. (canceled)

5. The electric stapler according to claim 4, wherein an elastic force of the pressure spring is greater than the resistance of the staple frame to press the staple into the paper.

6. The electric stapler according to claim 1, wherein the auxiliary nail pressing component comprises a lever and a pressure spring, a lower end of the pressure spring is in contact with the base, and an upper end of the pressure spring is in contact with one end of the lever abut against, so that the end of the lever away from the pressure spring always has a tendency to push the connecting shaft to move downward.

7. The electric stapler according to claim 6, wherein the lever comprises a main body, and one end of the main body close to the pressure spring is bent upwards to form a first connecting part, and the first connecting part comprises a blocking sheet extending laterally outwards, and the upper end of the pressure spring abuts against the blocking sheet.

8. The electric stapler according to claim 7, wherein an other end of the main body away from the pressure spring is bent upwards to form a second connecting part, and the second connecting part is provided with a pushing groove matched with the connecting shaft, an inner side wall of the pushing groove abuts against a circumferential outer surface of the connecting shaft.

9. The electric stapler according to claim 8, wherein one end of the second connecting part close to the corresponding main body is rotatably connected to the base through a rotating shaft.

10. The electric stapler according to claim 6, wherein an elastic force of the pressure spring is greater than resistance of the staple frame to press the staple into the paper.
